(19) United States
(12) Patent Application Publication
(10) Pub. No.: US 2020/0316740 A1
(43) Pub. Date: Oct. 8, 2020

(54) HOLDER AND MACHINE TOOL

(71) Applicant: FANUC CORPORATION, Minamitsuru-gun (JP)

(72) Inventor: Masahiro MUROTA, Minamitsuru-gun (JP)

(21) Appl. No.: 16/837,834

(22) Filed: Apr. 1, 2020

(30) Foreign Application Priority Data
Apr. 5, 2019 (JP) 2019-072810

(51) Int. Cl. B23Q 11/12

(52) U.S. Cl. CPC B23Q 11/126

(57) ABSTRACT

A holder for holding a plurality of parallel-arranged tubular members includes a first block and a second block, configured to hold the plurality of tubular members between the first and second blocks. The first block includes a plurality of first grooves formed in a surface thereof that faces the second block, the first grooves each extending in a direction in which the tubular members extend, and each of the first grooves has a semicircular shape when the first block is viewed from the direction in which the tubular members extend.

### CROSS-REFERENCE TO RELATED APPLICATION

This application is based upon and claims the benefit of priority from Japanese Patent Application No. 2019-072810 filed on Apr. 5, 2019, the contents of which are incorporated herein by reference.

### BACKGROUND OF THE INVENTION

### Field of the Invention

The present invention relates to a holder that holds a plurality of parallel-arranged tubular members as well as relating to a machine tool that includes a holder holding a plurality of parallel-arranged tubular members.

### Description of the Related Art

Conventionally, there are holders that hold a plurality of tubular members such as cables and tubes (for example, Japanese Laid-Open Patent Publication No. 2014-048761).

### SUMMARY OF THE INVENTION

Since the conventional holder has a multi-joint structure (an articulated structure) to produce flexibility, the holder makes intermittent motion as the moving part moves. When such a holder is applied to a machine tool that performs high-precision machining, there occurs a problem that intermittent motion of the holder produces disturbances on the machine tool and reduces the machining accuracy of the machine tool.

The present invention has been devised to solve the above problem, and it is therefore an object of the present invention to provide a holder capable of improving the machining accuracy of a machine tool, as well as providing a machine tool having such a holder.

A first aspect of the present invention resides in a holder for holding a plurality of parallel-arranged tubular members, the holder including a first block and a second block, configured to hold the plurality of tubular members therebetween. In this holder, the first block includes a plurality of first grooves formed in a surface thereof that faces the second block, the first grooves each being configured to extend in a direction in which the tubular members extend, and each of the first grooves has a semicircular shape when the first block is viewed from the direction in which the tubular members extend.

A second aspect of the present invention resides in a machine tool including the holder of the first aspect, including: a processing machine configured to move linearly on a horizontal plane and machine a workpiece based on a command for performing machining with machining accuracy of 100 nm or lower; and a main body configured to be connected to the processing machine via the plurality of tubular members. In this machine tool, the plurality of tubular members are configured to be connected at one end thereof to the main body, extend from the main body along the moving direction of the processing machine, and be connected at the other end to the processing machine, and the tubular members are arranged side by side in a direction orthogonal to the moving direction of the processing machine on the horizontal plane.

A third aspect of the present invention resides in a machine tool including the holder of the first aspect, including: a processing machine configured to move linearly on a vertical plane and machine a workpiece based on a command for performing machining with machining accuracy of 100 nm or lower; and a main body configured to be connected to the processing machine via the plurality of tubular members. In this machine tool, the plurality of tubular members are configured to be connected at one end thereof to the main body, extend from the main body along the moving direction of the processing machine, and be connected at the other end to the processing machine, and the tubular members are arranged side by side in the direction orthogonal to the moving direction of the processing machine on the vertical plane.

According to the present invention, since the holder moves smoothly together with the tubular members, the motion of the holder does not cause disturbances on the machine tool, so that the machining accuracy of the machine tool can be improved.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic perspective view of a machine tool;

FIG. 2 is a view taken in the direction of an arrow II in FIG. 1;

FIG. 3 is a perspective view of a first block;

FIG. 4 is a front view of the first block;

FIG. 5 is a side view of the first block;

FIG. 6 is a sectional view of the first block;

FIG. 7 is a sectional view of the first block;

FIG. 8 is a perspective view of a second block;

FIG. 9 is a front view of a first block;

FIG. 10 is a front view of a second block;

FIG. 11 is an exploded perspective view of a holder;

FIG. 12 is a schematic perspective view of a machine tool; and

FIG. 13 is a schematic perspective view of a machine tool.

### DESCRIPTION OF THE PREFERRED EMBODIMENTS

### First Embodiment

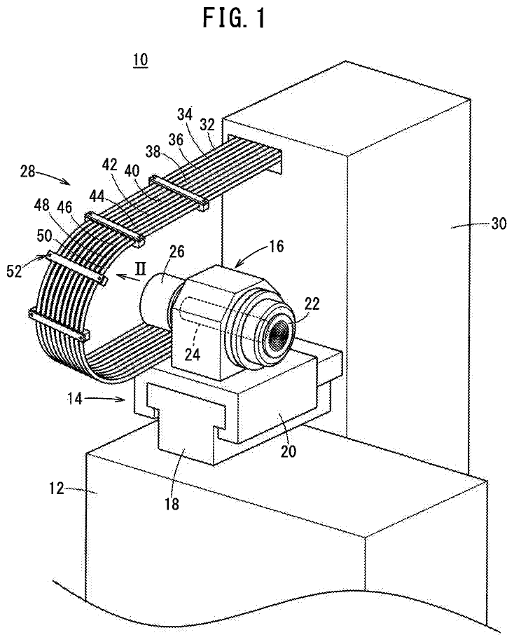

FIG. 1 is a schematic perspective view of a machine tool 10. The machine tool 10 according to the present embodiment is a precision processing machine that machines a workpiece based on commands for performing machining with machining accuracy of 100 nm or lower. The machine tool 10 is a lathe and includes a bed 12, a spindle support 14, a spindle stock 16 and an unillustrated tool post.

The spindle support 14 is arranged on the bed 12 and supports the spindle stock 16 so that the spindle stock can linearly move on a horizontal plane relative to the bed 12. The spindle support 14 has a linear guide 18 provided on the bed 12 and a spindle table 20 that can move along the linear guide 18. Rotational motion of an unillustrated motor is converted into linear motion by an unillustrated ball screw, so that the spindle table 20 linearly moves along the linear guide 18. Thus, the spindle stock 16 on the spindle table 20 moves linearly. Here, the spindle stock 16 corresponds to the processing machine of the present invention.

The spindle stock 16 includes a vacuum chuck 22 for holding a workpiece, a spindle shaft 24 that rotates together with the vacuum chuck 22, and a spindle motor 26 that rotates the spindle shaft 24. The vacuum chuck 22 attracts the workpiece under suction so as to fix the workpiece thereto. The spindle shaft 24 is arranged so as to extend in a direction parallel to the horizontal plane and orthogonal to the moving direction of the spindle stock 16. The spindle shaft 24 is supported by an air bearing and rotated by the spindle motor 26. The machine tool 10 performs a cutting process on the workpiece rotating together with the vacuum chuck 22 by means of an unillustrated cutting tool (tool bit) attached to the tool post.

Ten tubular members 28 are connected to the spindle stock 16. Each tubular member 28 is connected at its one end to a main body 30, extends from the main body 30 in the moving direction of the spindle stock 16, while the other end is connected to the spindle stock 16. These tubular members 28 are arranged side by side on a horizontal plane in the direction orthogonal to the direction in which the spindle stock 16 moves. The tubular members 28 are arranged to be curved in an arc shape from the main body 30 toward the spindle stock 16.

The tubular members 28 includes a motor coolant outlet tube 32, a manifold outlet tube 34, a power cable 36, a pulse coder signal cable 38, a thermistor signal cable 40, a vacuum chuck tube 42, a motor coolant inlet tube 44, a manifold inlet tube 46, a bearing air tube 48 and an air purge tube 50, arranged in this order from the side furthest from the spindle stock 16, in the direction orthogonal to the moving direction of the spindle stock 16 on the horizontal plane.

The motor coolant outlet tube 32 is a tube for discharging cooling water that has cooled the spindle motor 26 from the spindle stock 16 to the main body 30. The manifold outlet tube 34 is a tube for discharging cooling water that has cooled the interior of the spindle stock 16 from an unillustrated manifold of the spindle stock 16 to the main body 30. The power cable 36 is a cable through which electric power is supplied to the spindle motor 26. The pulse coder signal cable 38 is a cable for transmitting signals from an unillustrated pulse coder for detecting the rotary position of the spindle motor 26, to the main body 30. The thermistor signal cable 40 is a cable for transmitting signals from an unillustrated thermistor for detecting the temperature inside the spindle motor 26, to the main body 30.

The vacuum chuck tube 42 is a tube that is connected to the vacuum chuck 22 and through which air is suctioned. The motor coolant inlet tube 44 is a tube for supplying cooling water for cooling the spindle motor 26, from the main body 30 to the spindle stock 16. The manifold inlet tube 46 is a tube for supplying cooling water for cooling the interior of the spindle stock 16, from the main body 30 to the manifold of the spindle stock 16. The bearing air tube 48 is a tube for supplying a compressed air for the air bearing of the spindle shaft 24 from the main body 30 to the spindle stock 16. The air purge tube 50 is a tube that supplies a compressed air from the main body 30 to the spindle stock 16 so as to discharge air from the interior of the spindle stock 16 to the outside, in order to prevent cutting chips from entering the inside of the spindle stock 16.

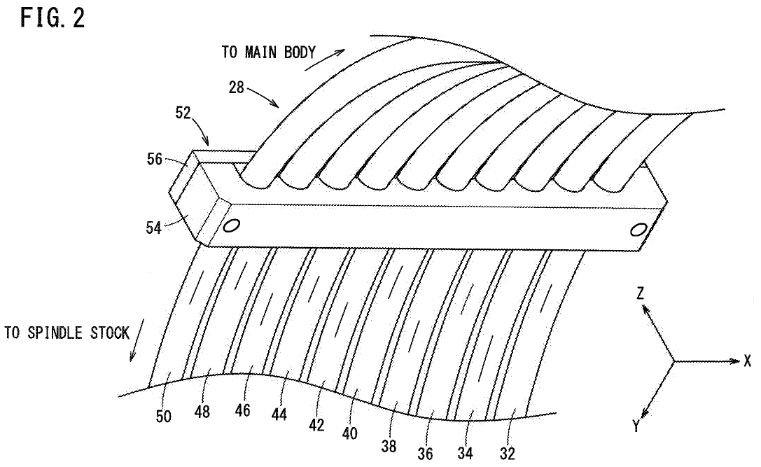

The tubular members 28 are held at multiple locations by multiple holders 52. FIG. 2 is a view taken in the direction of an arrow II in FIG. 1. As shown in FIG. 2, the holder 52 has a first block 54 and a second block 56, and holds the tubular members 28 between the first block 54 and the second block 56. The holder 52 holds the tubular members 28 in a state where the tubular members 28 are slightly pressed by the first block 54 and the second block 56. Further, the tubular members 28 are arranged at intervals by the holders 52, i.e., with a space being therebetween. The first block 54 is attached to the inner curved side of the tubular members 28 that are arranged so as to be curved in an arc shape while the second block 56 is attached to the outer curved side thereof.

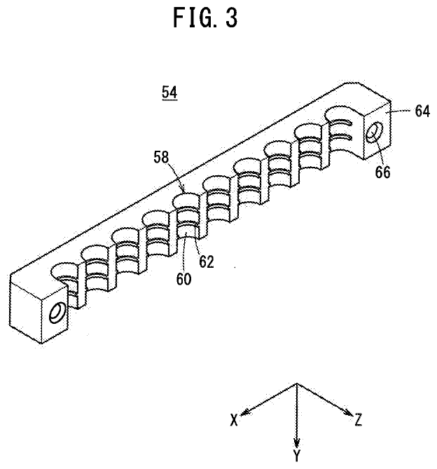

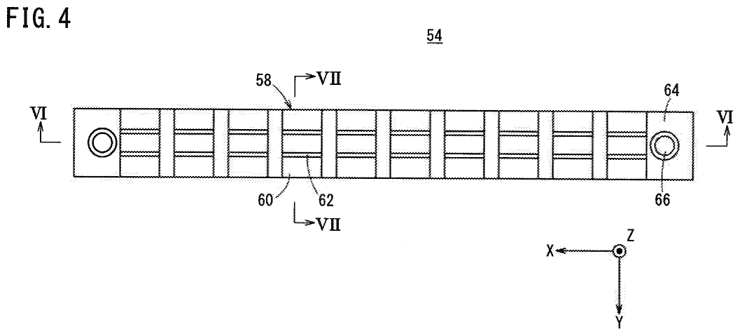

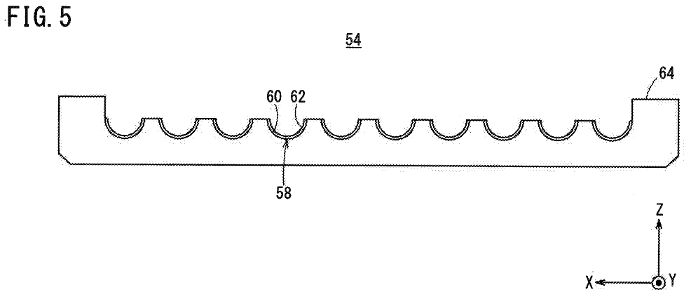

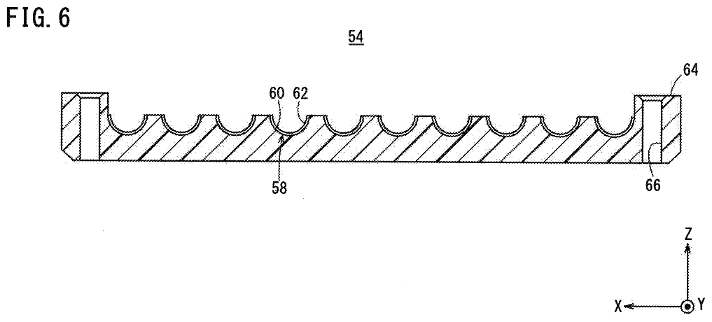

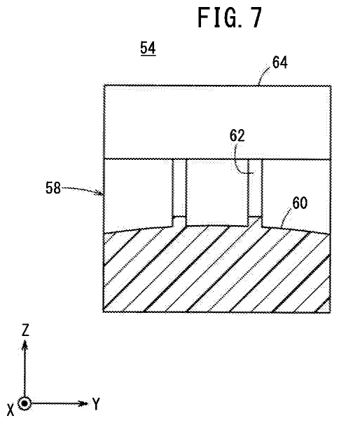

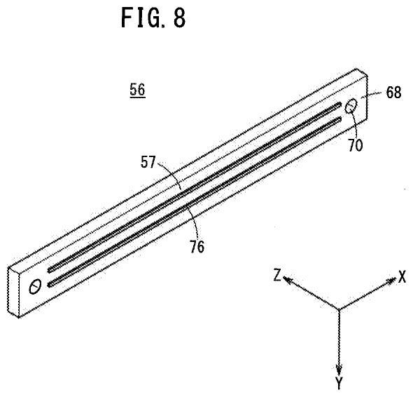

FIG. 3 is a perspective view of the first block 54. FIG. 4 is a front view of the first block 54. FIG. 5 is a side view of the first block 54. FIG. 6 is a sectional view of the first block 54. The cross section shown in FIG. 6 is a cross section cut along a plane parallel to the longitudinal direction of the first block 54. FIG. 7 is a sectional view of the first block 54. The cross section shown in FIG. 7 is a cross section cut along a plane parallel to the transverse direction of the first block 54. FIG. 8 is a perspective view of the second block 56.

In FIGS. 2 and 3 to 8, arrows indicating the X axis, the Y axis and the Z axis are shown. The X-axis extends parallel to the longitudinal direction of the holder 52 with its negative direction oriented from the motor coolant outlet tube 32 to the air purge tube 50 in FIG. 2. The Y-axis extends parallel to the transverse direction of the holder 52, with its negative direction oriented from the spindle stock 16 side to the main body 30 side in FIG. 2. The Z-axis extends orthogonal to the X-axis direction and the Y-axis direction, with its positive direction oriented from the first block 54 to the second block 56 in FIG. 2.

The first block 54 has ten first grooves 58 formed in a surface thereof that faces the second block 56 (the surface on the Z-axis positive side), the ten first grooves 58 each extending in a direction (the Y-axis direction) in which the tubular member 28 extends (FIGS. 3 and 4). When the first block 54 is viewed from the direction in which the tubular member 28 extends (Y-axis direction), each of the first grooves 58 is formed in a semicircular shape (FIGS. 3, 5, and 6).

The first grooves 58 each have two first projections 62 projecting from the bottom surface 60 of the first groove 58 (FIGS. 3 to 7). When the first block 54 is viewed from the second block 56 side (the Z-axis positive side), the first projection 62 is formed linearly extending in a direction orthogonal to the direction in which the first groove 58 extends (FIGS. 3 and 4). The bottom surface 60 of each first groove 58 is formed to be curved so as to be convex toward the second block 56 (the Z-axis positive side) along the direction (Y-axis direction) in which the first groove 58 extends (FIG. 7).

A pair of first fastening portions 64 are formed at the longitudinal ends of the first block 54 so as to project beyond the top of the first groove 58 toward the second block 56 (in the Z-axis positive direction). Each first fastening portion 64 has a first through hole 66 that penetrates the first block 54 in the Z-axis direction.

The second block 56 is formed in a plate shape. The second block 56 has two second projections 76 formed on a facing surface 57 (the surface on the Z-axis negative side) thereof that faces the first block 54, each second projection projecting from the facing surface 57 (FIG. 8). When the second block 56 is viewed from the first block 54 side (the Z-axis negative side), the second projection 76 is formed in a linear shape extending in the longitudinal direction of the second block 56. The second block 56 has two second fastening portions 68 at respective both ends in its longitudinal direction. In each of the second fastening portions 68, a second through hole 70 penetrating the second block 56 in the Z-axis direction is formed. An unillustrated fastening member is inserted into the first through hole 66 and the second through hole 70 in a state where the tubular members 28 are sandwiched and held between the first block 54 and the second block 56, so that the first block 54 and the second block 56 are joined together.

In the present embodiment, the first block 54 and the second block 56 have the first projections 62 and the second projections 76 respectively. However, it is possible to configure such that the first block 54 alone has the first projections 62 while the second block 56 has no second projections 76. In this case, the facing surface 57 of the second block 56 is formed flat. Alternatively, it may be configured such that the second block 56 alone has the second projections 76 while the first block 54 has no first projections 62.

Further, in the present embodiment, the first block 54 has two first projections 62 and the second block 56 has two second projections 76, but the first block 54 may have only one first projection 62, or three or more first projections 62. Also, the second block 56 may have only one second projection 76, or three or more second projections 76.

### Operation and Effects

Conventionally, there have been holders for holding the multiple tubular members 28 of the machine tool 10. However, since the conventional holder has a multi-joint structure (an articulated structure) to produce flexibility, the holder cannot help but make intermittent motion as the moving part moves. When a holder having a multi-joint structure is applied to a precision processing machine that performs high-precision machining such as the machine tool 10 of the present embodiment, such intermittent motion of the holder causes disturbance on the machine tool 10, so that the processing accuracy of the machine tool 10 is reduced.

To deal with this, the present embodiment is configured such that the tubular members 28 are held between the first block 54 and the second block 56 of the holder 52 at multiple locations. Further, the facing surface of the first block 54 facing the second block 56 is formed with multiple first grooves 58 that each extend in the direction in which the tubular members 28 extend, and each of the first grooves 58 has a semicircular shape when the first block 54 is viewed from the axial direction of the tubular member 28. As a result, the holder 52 can move smoothly together with the tubular members 28, so that the motion of the holder 52 does not cause any disturbance on the machine tool 10, and the processing accuracy of the machine tool 10 can be improved.

In the present embodiment, the first grooves 58 each have two first projections 62 projecting from the bottom surface 60 of the first groove 58. With this configuration, the holder 52 can be prevented from moving relative to the tubular members 28.

In the present embodiment, when the first block 54 is viewed from the second block 56 side (the Z-axis positive side), the first projections 62 are formed linearly so as to be orthogonal to the direction in which the first groove 58 extends. This makes it possible to prevent the holder 52 from moving relative to the tubular members 28.

Further, in the present embodiment, the first block 54 is attached to the inner curved side of the tubular members 28 that are arranged so as to curve in an arc shape, and the second block 56 is attached to the outer curved side thereof. The bottom surface of each first groove 58 is formed to be curved so as to be convex toward the second block 56 (the Z-axis positive side) in the direction (Y-axis direction) in which the first groove 58 extends. When the spindle stock 16 moves in a direction approaching the main body 30, the curvature of the arc shape of the tubular members 28 increases, so that the tubular members 28 are pressed against the bottom surfaces 60 of the first grooves 58. However, since the first groove 58 of the first block 54 is curved, it is possible to alleviate compression of the tubular members 28 caused by the first grooves 58.

In the present embodiment, the surface of the second block 56 facing the first block 54 (the surface on the Z-axis negative side) is formed in a flat shape. Thus, the second block 56 is formed in a simple shape, which makes it possible to easily produce the second block 56.

Further, in the present embodiment, the spindle stock 16 is provided so as to move along a horizontal plane and machine a workpiece in accordance with commands for machining the workpiece with machining accuracy of 100 nm or lower. The spindle stock 16 is connected to the main body 30 via multiple tubular members 28. These multiple tubular members 28 are arranged side by side in a horizontal plane, along a direction orthogonal to the moving direction of the spindle stock 16. As a result, the tubular members 28 can move following the motion of the spindle stock 16, so that the machining accuracy of the machine tool 10 can be improved.

In the present embodiment, the motor coolant outlet tube 32, the manifold outlet tube 34 and the power cable 36 are arranged on a side away from the spindle stock 16 in a direction orthogonal to the moving direction of the spindle stock 16 on the horizontal plane. Further, the motor coolant inlet tube 44 and the manifold inlet tube 46 are arranged on a side near the spindle stock 16. Thus, the motor coolant outlet tube 32, the manifold outlet tube 34 and the power cable 36, which generate relatively high temperatures, are arranged apart from the motor coolant inlet tube 44 and the manifold inlet tube 46, which generate relatively low temperatures. Thus, it is possible to avoid increase in temperature of the cooling water flowing through the motor coolant inlet tube 44 and the manifold inlet tube 46.

Further, the pulse coder signal cable 38 and the thermistor signal cable 40, which are signal lines relatively insensitive to heat, are laid out between the motor coolant outlet tube 32, the manifold outlet tube 34 and the power cable 36, and the motor coolant inlet tube 44 and the manifold inlet tube 46. Thus, it is possible to prevent elevation in temperature of the cooling water flowing through the motor coolant inlet tube 44 and the manifold inlet tube 46.

Moreover, the motor coolant inlet tube 44 and the manifold inlet tube 46 are arranged between the vacuum chuck tube 42, and the bearing air tube 48 and the air purge tube 50, which have relatively high heat insulating properties because air flows through them. This also prevents elevation in temperature of the cooling water flowing through the motor coolant inlet tube 44 and the manifold inlet tube 46.

### Second Embodiment

In this embodiment, the shape of a first projection 62 of a first block 54 and the shape of a second projection 76 of a second block 56 are different from those of the first embodiment.

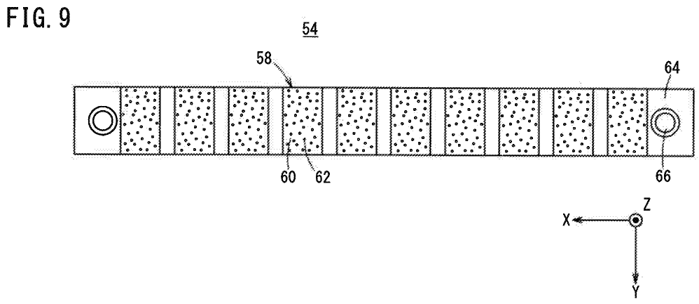

FIG. 9 is a front view of the first block 54. The first block 54 has multiple first grooves 58 formed in a surface thereof that faces the second block 56 (a surface on the Z-axis positive side), the first grooves 58 each extending in a direction in which the tubular members 28 extend (i.e., in the Y-axis direction). The first grooves 58 each have multiple first projections 62 projecting from the bottom surface 60 of the first groove 58. When the first block 54 is viewed from the second block 56 side (the Z-axis positive side), the first projections 62 are formed as dots (i.e., each first projection is formed into a dot shape).

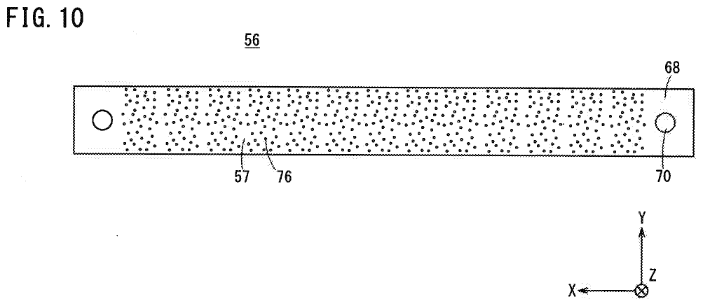

FIG. 10 is a front view of the second block 56. The second block 56 has multiple second projections 76 formed on a facing surface 57 thereof (a surface on the Z-axis negative side) that faces the first block 54, the second projections 76 projecting from the facing surface 57. When the second block 56 is viewed from the first block 54 side (the Z-axis negative side), the second projections 76 are formed as dots.

It is also possible to configure such that the first block 54 alone has the first projections 62 while the second block 56 has no second projections 76. Alternatively, it may be configured such that the second block 56 alone has the second projections 76 while the first block 54 has no first projections 62.

Here, the shapes of the first projections 62 of the first grooves 58 of the first block 54 may be different for each first groove 58. Further, the shapes of the second projections 76 of the second block 56 may be different for different portions of the facing surface 57.

### Operation and Effects

In this embodiment, when the first block 54 is viewed from the second block 56 side (the Z-axis positive side), the first projections 62 are formed as dots. With this configuration, the holder 52 can be prevented from moving relative to the tubular members 28.

### Third Embodiment

In the third embodiment, the shapes of a first block 54 and a second block 56 are different from those of the first embodiment.

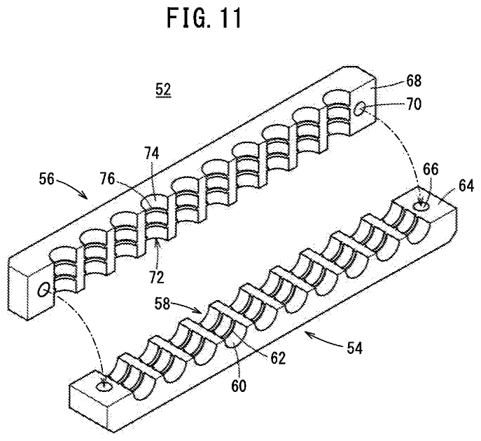

FIG. 11 is an exploded perspective view of a holder 52. In the first embodiment, the first fastening portion 64 of the first block 54 is formed to protrude beyond the first grooves 58. On the other hand, in this embodiment, a first fastening portion 64 is formed at the same height as that of both end portions of the first groove 58 in its width direction.

In the present embodiment, the second block 56 is formed in the same shape as the first block 54. The second block 56 has multiple second grooves 72 formed in a surface thereof that faces the first block 54, the second grooves 72 extending in a direction in which the tubular members 28 extend. When the second block 56 is viewed from the direction in which the tubular members 28 extend, each of the second grooves 72 is formed in a semicircular shape. The second grooves 72 each have two second projections 76 projecting from the bottom surface 74 of the second groove 72. When the second block 56 is viewed from the first block 54 side, the second projection 76 is formed linearly extending in a direction orthogonal to the direction in which the second groove 72 extends.

The second block 56 has two second fastening portions 68 formed at both ends thereof in the longitudinal direction. The second fastening portion 68 is formed at the same height as that of both end portions of the second groove 72 in its width direction. Each second fastening portion 68 has a second through hole 70 that penetrates the second block 56 in the Z-axis direction.

In addition, the first projections 62 formed in the first groove 58 of the first block 54 and the second projections 76 formed in the second groove 72 of the second block 56 may be dots as in the first projections 62 of the second embodiment. Further, the shapes of the first projections 62 and the second projections 76 may differ from each other, depending on each of first grooves 58 and second grooves 72.

### Operation and Effects

In the present embodiment, the multiple second grooves 72 extending in the direction in which the tubular members 28 extend are formed in the surface of the second block 56 facing the first block 54, and each second groove 72 is formed in a semicircular shape when viewed from the axial direction of the tubular members 28 of the second block 56. As a result, the holder 52 can move smoothly together with the tubular members 28, so that the motion of the holder 52 does not produce any disturbance on the machine tool 10, and degradation of the processing accuracy of the machine tool 10 can be reduced.

Further, in the present embodiment, the second groove 72 has two second projections 76 projecting from the bottom surface 74 of the second groove 72. Thus, it is possible to prevent the holder 52 from moving relative to the tubular members 28.

### Modified Examples

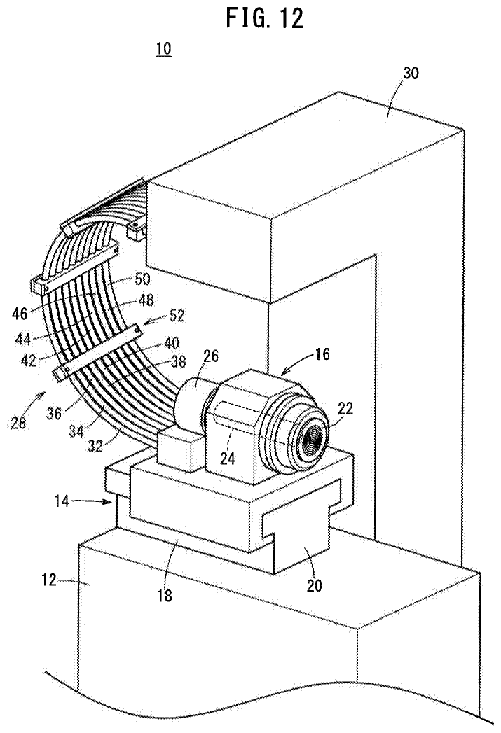

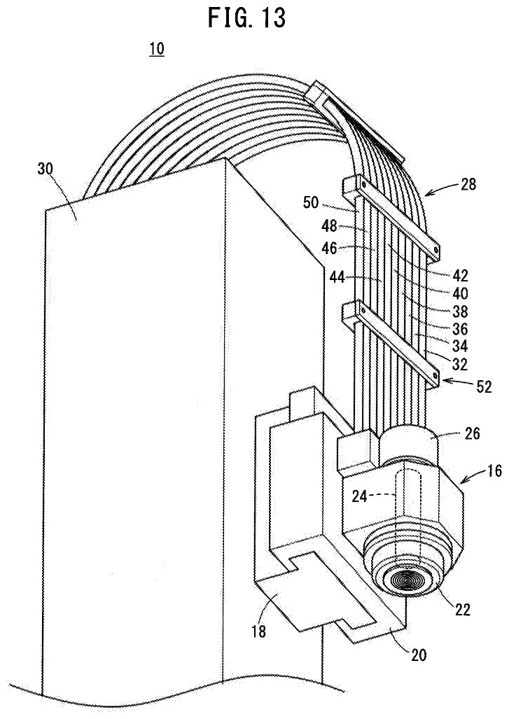

FIGS. 12 and 13 are schematic perspective views of a machine tool 10.

In the machine tool 10 in the first to third embodiments, the spindle shaft 24 is provided so as to extend in parallel with the horizontal plane, and the spindle stock 16 is configured to be movable on the horizontal plane in the direction orthogonal to the direction in which the spindle shaft 24 extends.

Instead of the configuration of the above machine tool 10, the spindle stock 16 may be provided so as to be movable on a horizontal plane, in the direction in which the spindle shaft 24 extends, as shown in FIG. 12. In this case, the tubular members 28 are arranged side by side on a horizontal plane, along the direction orthogonal to the moving direction of the spindle stock 16. The tubular members 28 are arranged so as to be curved in an arc shape from the main body 30 toward the spindle stock 16.

Alternatively, as shown in FIG. 13, the spindle shaft 24 is provided so as to extend in parallel with a vertical plane while the spindle stock 16 may be provided so as to be movable on the vertical plane, in the direction in which the spindle shaft 24 extends. In this case, the tubular members 28 are arranged side by side on a vertical plane, along the direction orthogonal to the moving direction of the spindle stock 16. The tubular members 28 are arranged so as to be curved in an arc shape from the main body 30 toward the spindle stock 16.

### Technical Ideas Obtained from the Embodiments

The technical ideas that can be grasped from the above embodiments are described below.

The holder (52) for holding a plurality of parallel-arranged tubular members (28) includes a first block (54) and a second block (56), configured to hold the plurality of tubular members therebetween, wherein the first block includes a plurality of first grooves (58) formed in a surface thereof that faces the second block, the first grooves each being configured to extend in a direction in which the tubular members extend, and each of the first grooves has a semicircular shape when the first block is viewed from the direction in which the tubular members extend. This configuration allows the holder to move smoothly together with the tubular members, so that the motion of the holder does not cause any disturbance on the machine tool (10), and the processing accuracy of the machine tool can be improved.

In the above holder, each of the first grooves may be configured to have one or more first projections (62) projecting from the bottom surface (60) of the first groove. This makes it possible to prevent the holder from moving relative to the tubular members.

In the above holder, each of the first projections may be formed into a dot shape when the first block is viewed from the second block side. This makes it possible to prevent the holder from moving relative to the tubular members.

In the above holder, each of the first projections may be configured to have a linear shape extending in the direction orthogonal to the direction in which the first groove extends when the first block is viewed from the second block side. This makes it possible to prevent the holder from moving relative to the tubular members.

In the above holder, the first block may be attached to the inner curved side of the tubular members that are arranged so as to be curved in an arc shape, and the bottom surface of the first groove may be configured to be curved so as to be convex toward the second block along the direction in which the first groove extends. This configuration makes the curvature of the arc shape of the tubular members increase, so that it is possible to alleviate compression of the tubular members by the first groove when the tubular members are pressed against the bottom surface of the first groove.

In the above holder, the surface of the second block that faces the first block may be formed flat. With this configuration, the second block is formed in a simple shape, thereby making it possible to easily manufacture the second block 56.

In the above holder, the second block may be configured to have a plate shape and have one or more second projections (76) projecting from the surface of the second block that faces the first block.

In the above holder, each of the second projections may be formed into a dot shape when the second block is viewed from the first block side. This makes it possible to prevent the holder from moving relative to the tubular members.

In the above holder, each of the second projections may be configured to have a linear shape extending in the longitudinal direction of the second block when the second block is viewed from the first block side. This makes it possible to prevent the holder from moving relative to the tubular members.

In the above holder, the second block may include a plurality of second grooves (72) formed in the surface thereof that faces the first block, the second grooves each being configured to extend in the direction in which the tubular members extend, and each of the second grooves has a semicircular shape when the second block is viewed from the direction in which the tubular members extend. This configuration allows the holder to move smoothly together with the tubular members, so that the motion of the holder does not cause any disturbance on the machine tool, and the processing accuracy of the machine tool can be improved.

In the above holder, each of the second grooves may be configured to have one or more second projections (76) projecting from the bottom surface (74) of the second groove. This makes it possible to prevent the holder from moving relative to the tubular members.

In the above holder, each of the second projections may be formed into a dot shape when the second block is viewed from the first block side. This makes it possible to prevent the holder from moving relative to the tubular members.

In the above holder, each of the second projections may be configured to have a linear shape extending in the direction orthogonal to the direction in which the second groove extends when the second block is viewed from the first block side.

The machine tool (10) including the above-described holder includes: a processing machine (16) configured to move linearly on a horizontal plane and machine a workpiece based on a command for performing machining with machining accuracy of 100 nm or lower; and a main body (30) configured to be connected to the processing machine via the plurality of tubular members, wherein the plurality of tubular members are configured to be connected at one end thereof to the main body, extend from the main body along the moving direction of the processing machine, and be connected at the other end to the processing machine, and the tubular members are arranged side by side in the direction orthogonal to the moving direction of the processing machine on the horizontal plane. With this configuration, the tubular members can move following the motion of the processing machine, so that the machining accuracy of the machine tool can be improved.

In the above machine tool, the plurality of tubular members may be arranged side by side such that some tubular members of the tubular members that are arranged on one side in the direction orthogonal to the moving direction of the processing machine on the horizontal plane generate higher temperature than the other tubular members of the tubular members that are arranged on the other side. This arrangement makes it possible to avoid elevation in temperature of the tubular members that generate relatively low temperature.

The machine tool (10) including the above-described holder includes: a processing machine (16) configured to move linearly on a vertical plane and machine a workpiece based on a command for performing machining with machining accuracy of 100 nm or lower; and a main body (30) configured to be connected to the processing machine via the plurality of tubular members, wherein the plurality of tubular members are configured to be connected at one end thereof to the main body, extend from the main body along the moving direction of the processing machine, and be connected at the other end to the processing machine, and the tubular members are arranged side by side in the direction orthogonal to the moving direction of the processing machine on the vertical plane. With this configuration, the tubular members can move following the motion of the processing machine, so that the machining accuracy of the machine tool can be improved.

In the above machine tool, the plurality of tubular members may be arranged side by side such that some members of the tubular members that are arranged on one side in the direction orthogonal to the moving direction of the processing machine on the vertical plane generate higher temperature than the other members of the tubular members that are arranged on the other side. This arrangement makes it possible to avoid elevation in temperature of the tubular members that generate relatively low temperature.

The present invention is not particularly limited to the embodiments described above, and various modifications are possible without departing from the essence and gist of the present invention.

What is claimed is:

1. A holder for holding a plurality of parallel-arranged tubular members, the holder comprising a first block and a second block, configured to hold the plurality of tubular members therebetween,
wherein the first block includes a plurality of first grooves formed in a surface thereof that faces the second block, the first grooves each being configured to extend in a direction in which the tubular members extend, and each of the first grooves has a semicircular shape when the first block is viewed from the direction in which the tubular members extend.

2. The holder according to claim 1, wherein each of the first grooves is configured to have one or more first projections projecting from a bottom surface of the first groove.

3. The holder according to claim 2, wherein each of the first projections is formed into a dot shape when the first block is viewed from a second block side.

4. The holder according to claim 2, wherein each of the first projections is configured to have a linear shape extending in a direction orthogonal to a direction in which the first groove extends when the first block is viewed from a second block side.

5. The holder according to claim 1, wherein:
the first block is attached to an inner curved side of the tubular members that are arranged so as to be curved in an arc shape; and
a bottom surface of the first groove is configured to be curved so as to be convex toward the second block along a direction in which the first groove extends.

6. The holder according to claim 1, wherein a surface of the second block that faces the first block is formed flat.

7. The holder according to claim 1, wherein the second block is configured to have a plate shape and have one or more second projections projecting from a surface of the second block that faces the first block.

8. The holder according to claim 7, wherein each of the second projections is formed into a dot shape when the second block is viewed from a first block side.

9. The holder according to claim 7, wherein each of the second projections is configured to have a linear shape extending in a longitudinal direction of the second block when the second block is viewed from a first block side.

10. The holder according to claim 1, wherein the second block includes a plurality of second grooves formed in a surface thereof that faces the first block, the second grooves each being configured to extend in a direction in which the tubular members extend, and each of the second grooves has a semicircular shape when the second block is viewed from the direction in which the tubular members extend.

11. The holder according to claim 10, wherein each of the second grooves is configured to have one or more second projections projecting from a bottom surface of the second groove.

12. The holder according to claim 11, wherein each of the second projections is formed into a dot shape when the second block is viewed from a first block side.

13. The holder according to claim 11, wherein each of the second projections is configured to have a linear shape extending in a direction orthogonal to a direction in which the second groove extends when the second block is viewed from a first block side.

14. A machine tool including the holder according to claim 1, comprising:
a processing machine configured to move linearly on a horizontal plane and machine a workpiece based on a command for performing machining with machining accuracy of 100 nm or lower; and
a main body configured to be connected to the processing machine via the plurality of tubular members, wherein:
the plurality of tubular members are configured to be connected at one end thereof to the main body, extend from the main body along moving direction of the processing machine, and be connected at another end to the processing machine; and
the tubular members are arranged side by side in a direction orthogonal to the moving direction of the processing machine on the horizontal plane.

15. The machine tool according to claim 14, wherein the plurality of tubular members are arranged side by side in a manner that some of the tubular members that are arranged on one side in a direction orthogonal to the moving direction of the processing machine on the horizontal plane generate higher temperature than others of the tubular members that are arranged on another side.

16. A machine tool including the holder according to claim 1, comprising:
a processing machine configured to move linearly on a vertical plane and machine a workpiece based on a command for performing machining with machining accuracy of 100 nm or lower; and
a main body configured to be connected to the processing machine via the plurality of tubular members, wherein:
the plurality of tubular members are configured to be connected at one end thereof to the main body, extend from the main body along moving direction of the processing machine, and be connected at another end to the processing machine; and
the tubular members are arranged side by side in a direction orthogonal to the moving direction of the processing machine on the vertical plane.

17. The machine tool according to claim 16, wherein the plurality of tubular members are arranged side by side in a manner that some of the tubular members that are arranged on one side in a direction orthogonal to the moving direction of the processing machine on the vertical plane generate higher temperature than others of the tubular members that are arranged on another side.
